(19) United States
(12) Patent Application Publication
(10) Pub. No.: US 2012/0286915 A1
(43) Pub. Date: Nov. 15, 2012

(54) Electrical Device And A Method For Manufacturing The Device

(76) Inventors: Alessandro Mattozzi, Sundbyberg (SE); Dariusz Bednarowski, Krakow (PL); Hoan Le, Raleigh, NC (US); Lukasz Malinowski, Krakow (PL); Roman Pernica, Brno (CZ)

(21) Appl. No.: 13/555,988

(22) Filed: Jul. 23, 2012

Related U.S. Application Data
(63) Continuation of application No. PCT/EP2011/050695, filed on Jan. 19, 2011.

(30) Foreign Application Priority Data
Jan. 29, 2010 (EP) 10152091.4

(51) Int. Cl. H01F 27/02; B05D 5/12; B29C 39/10

(52) U.S. Cl. 336/96; 264/261; 427/58

(57) ABSTRACT

An electric device including windings and magnetic cores, the device further including an encapsulating plastic encasement which includes an inner part and an outer part, the inner part being an inner insulating resin composition of thermosetting material encapsulating components of the device, and the outer part being a shell of a thermoplastic material which at least partly encloses the resin composition in contact therewith. Some components of the device are located in inner boxes encapsulated by the inner insulating resin composition. The invention also relates to a method for manufacturing such a device. According to the method the shell is used as the mould form when moulding the insulating resin composition, and some components of the device are placed in boxes before inserting them into the shell.

### CROSS-REFERENCE TO RELATED APPLICATIONS

The present application is a continuation of pending International patent application PCT/EP2011/050695 filed on Jan. 19, 2011 which designates the United States and claims priority from European patent application 10152091.4 filed on Jan. 29, 2010. The content of all prior applications is incorporated herein by reference.

### FIELD OF THE INVENTION

The present invention in a first aspect relates to an electric device including at least one winding and at least one magnetic core, the device being encapsulated in a plastic encasement, which encasement includes an inner part and an outer part, the inner part being an inner insulating resin composition of thermosetting material encapsulating the electric device, the outer part being a shell which at least partly encloses the resin composition in contact therewith, and the shell is made of a thermoplastic material.

In a second aspect the invention relates to a method for manufacturing such an electric device, which method includes the steps of providing a shell, inserting at least some of the components into the shell and moulding an insulating resin composition of thermosetting material into the shell, using the shell as a mould form, such that the resin encapsulates the components, and the shell provided is of a thermoplastic material that is used as the mould form when moulding the insulating resin composition of thermosetting material.

### BACKGROUND OF THE INVENTION

An outdoor electrical device (such as a transformer) having a dry-type construction includes at least one electrical component (such as a core/coil assembly) encapsulated in a solid insulating material to insulate and seal the electrical component from the outside environment. Conventionally, the electrical component is encapsulated in a single casting resin that is formulated to meet all electrical, chemical and thermal requirements for insulating the electrical device during its operation. In addition, this single casting resin is formulated to withstand harsh outdoor environmental conditions to preserve its insulating properties and maintain an aesthetic appearance. Typically, the single casting resin is an epoxy resin. An example of an epoxy resin especially formulated for use as a single casting resin is disclosed in U.S. Pat. No. 5,939,472 to Ito et al., which is hereby incorporated by reference. A further example of a single casting resin for a transformer is disclosed in GB2037087.

Since a single casting resin is required to meet so many different requirements, the single casting resin is typically quite expensive to produce. In addition, the single casting resin does not provide the most optimum overall characteristics. In the past, a few electrical devices have used multiple resins in their construction. An example of an electrical device using multiple resins is an embedded vacuum interrupter having a current sensor, which is manufactured by ABB Calor Emag Mittelspannung GmbH of Ratingen, Germany. The insulation system in this embedded vacuum interrupter was developed to reduce partial discharge and has an inner layer composed of a rigid bisphenol A-based epoxy resin and an outer layer composed of a rigid cycloaliphatic epoxy resin. Another example of an electrical device using multiple resins is disclosed in U.S. Pat. No. 5,656,984 to Paradis et al. The Paradis et al. patent discloses a transformer having a silicone foam rubber sheet material wrapped around a metal core. The wrapped core and a coil are encapsulated in a body composed of Araldite CW229, which is a rigid epoxy resin. The foam rubber sheet material helps protect the core when the epoxy resin cures and shrinks. An outer casing composed of fiberglass is disposed around the body of epoxy resin.

WO 2008127575, herewith incorporated by reference, describes a further example of a double casting resin. An electrical apparatus, such as an instrument transformer has a plastic encasement encapsulating the device. It consists of an outer shell in which a cured resin composition is enclosed and the resin encapsulates the electric device. The outer shell is made of an epoxy resin composition.

EP375851 discloses another example of a transformer embedded in a double layer plastic encapsulation, both the layers being of thermoplastic material.

For other devices than those, which like a transformer has a magnetic core and winding it is known to have a double layer plastic encapsulation.

Examples thereof are disclosed in US 2006003137, US 2009004557 and JP 10156982. The disclosed devices are, however not suitable for transformer-applications.

Common to the known devices having a double casting resin for transformers is that the outer shell consists of a thermosetting plastic. This material for the outer shell entails some drawbacks, in particular regarding the manufacture thereof since the manufacturing of the insulating resin composition that encapsulates the electric device require costly processes such as APG or providing casting tools.

### SUMMARY OF THE INVENTION

One object of the present invention is to attain an electric device of the kind of question that is improved regarding the properties of the double casting resin.

This object is according to the first aspect of the invention achieved by an electric device including at least one winding and at least one magnetic core, the device further including an encapsulating plastic encasement, which encasement includes an inner part and an outer part, the inner part being an inner insulating resin composition of thermosetting material encapsulating components of the electric device, and the outer part being a shell which at least partly encloses the resin composition in contact therewith, the shell being made of a thermoplastic material, wherein at least some of the components of the electric device are located in at least one inner box encapsulated by the inner insulating resin composition.

With such an outer shell, the shell itself becomes particularly suitable to be used as the mould form for moulding the inner part of thermosetting material that constitutes the insulating resin. This significantly simplifies the manufacturing in comparison with the methods mentioned above that are required for the devices according to prior art. The production thereby can be made much faster, which allow production at large series at competitive cost.

Furthermore a thermoplastic material is less friable than the epoxy material used in the known devices. The shell thus will have a higher toughness resulting in better mechanical stability. The use of an outer layer that is made of thermoplastic material in combination with an inner layer of thermosetting material provides an encapsulation for a transformer where the material properties of the respective layer are combined in an optimized way for such an application. The use of thermoplastic material for the shell is also less harmful with regards to environmental aspects since it is more suitable for recycling than a thermosetting material.

By means of the at least one inner box, the position of the various components of the electric device within the outer shell can be well-defined and structured with regards to their positions relative to each other as well as relative to the outer shell. The manufacturing process will also be improved due to the modularisation of the components. When there are a plurality of windings and magnetic cores, these can be located in one single inner box or two or more such boxes.

The outer shell can either completely enclose the inner insulating resin composition or, alternatively be partly open, e.g. be cup-shaped.

According to a preferred embodiment of the invented device, the electric device is a sensor or a transformer.

These are important applications for an encapsulating structure according to the present invention, and is therefore of particular interest. The sensor might be constituted by one single winding and one single magnetic core. For a transformer e.g. a measure transformer or a dry transformer there will be two or more windings and magnetic cores, respectively.

According to a further preferred embodiment, the electric device is a transformer for a voltage higher than 1 kV.

For such transformers the advantages of the present invention are especially important, in particular for transformers for a voltage exceeding 12 kV.

According to a further preferred embodiment at least one of the inner box(es) is made of a thermoplastic material.

Using such a material also for the inner box/boxes has advantages of similar kind as the outer shell.

According to a further preferred embodiment, the internal surface of the shell has a rough or coated surface.

It is important that the inner insulating resin composition is adhered to the shell. When the shell has an inner surface that is rough or coated with a suitable coating, the adherence will be stronger.

According to a further preferred embodiment, the external surface of the at least one inner box has an outer layer of semi conductive paint or tape. The external surface of the shell may have an outer layer of semi conductive paint or tape.

By such an outer layer a good field control of the electric device can be attained.

According to a further preferred embodiment, the material of the shell is selected from the group of materials consisting of PBT (polybutulene terephtalate), PET (polyethylene terephtalate), PA (polyamide, aromatic or partially aromatic) PPSU (polyphenylsulfone), PSU (phenylsulfone), PES (polyethersulfone) and PPS polyphenylene sulphide).

These thermoplastic materials are particularly suitable for the outer shell. According to a further preferred embodiment, the inner part has a tensile elongation at break of greater than 5%.

This relatively soft material provides a better protection since tensions that might occur in the inner part, e.g. due to temperature rise will not result in breakage of the encapsulation.

According to a further preferred embodiment, the thickness of the inner part is greater than the thickness of the outer part.

Thereby a good insulation and a safe protection of the components of the electric device is achieved.

According to another advantageous embodiment of the electric device according to the present invention, the at least one inner box is at least partially filled with a filler comprising an insulating resin composition. The filler may comprise an insulating resin composition of thermosetting material. The filler may encapsulate at least some of the components of the electric device located in the at least one inner box. The material of the filler may correspond to any of the materials which the inner part may be made of. The material of the filler does not need to be the same as the material of the inner part. The filler may be liquid or solid. By means of these embodiments, the mechanical strength of the electric device is further improved, and the production thereof is further facilitated.

An object of the invention is according to the second aspect thereof achieved by a method for manufacturing an electric device, which device includes at least one winding and at least one magnetic core and including the steps of providing a shell, inserting at least some of the components into the shell and moulding an insulating resin composition of thermosetting material into the shell such that the resin composition encapsulates said components, the shell provided being of a thermoplastic material that is used as the mould form when moulding the insulating resin composition of thermosetting material, wherein at least some of the components of the electric device are placed in at least one box before inserting them into the shell, and the at least one inner box is encapsulated by the inner insulating resin composition. Preferably, the shell is moulded.

According to a further preferred embodiment, the internal surface of the shell is treated by roughening or coating the surface before moulding the insulating resin composition.

According to a further preferred embodiment, an outer layer of semi conductive paint or tape is applied to the external surface of the at least one inner box. An outer layer of semi conductive paint or tape may be applied to the external surface of the shell.

According to further preferred embodiments, the method is used for manufacturing an electric device according to the present invention, in particular to any of the preferred embodiments thereof.

According to another advantageous embodiment of the method according to the present invention, the at least one box is at least partially filled with a filler comprising an insulating resin composition. The filler may comprise an insulating resin composition of thermosetting material. The filler may encapsulate at least some of the components of the electric device located in the at least one box. The material of the filler may correspond to any of the materials which the inner part may be made of. The material of the filler does not need to be the same as the material of the inner part. The filler may be liquid or solid. The at least one box may be filled with the filler before placing components of the electric device in the at least one box, or components of the electric device may be placed in the at least one box before filling the box with the filler.

The invented method and the preferred embodiments thereof, have advantages that are similar to those of the invented electric device and the preferred embodiments thereof, which advantages have been described above.

The preferred embodiments of the invention are set out herein. It is to be understood that further preferred embodiments of course can be constituted by any possible combination of the preferred embodiments mentioned above and by any possible combination of these and the features described in the examples below or anywhere else in the description.

### BRIEF DESCRIPTION OF THE DRAWINGS

FIG. 1 is a schematic section through an electrical device according to a first example of the invention;

FIG. 2 is a schematic section through an electric device according to a second example of the invention;

FIG. 3 is a schematic section through an electric device according to a second example of the invention;

FIGS. 4 and 5 are enlarged sections through a part of the inner surface of the shell in any of FIGS. 1 to 3 according to alternative examples;

FIG. 6 is an enlarged section through a part of the outer surface of the at least one inner box in any of FIGS. 1 to 3 according to a further alternative example;

FIG. 7 is an exploded view of a detail of an electric device according to a realization of any of the examples of FIG. 2 or 3; and

FIG. 8 is a perspective view of a detail of an electric device according to a realization of any of the examples of FIGS. 1 to 3.

### DETAILED DESCRIPTION OF THE INVENTION

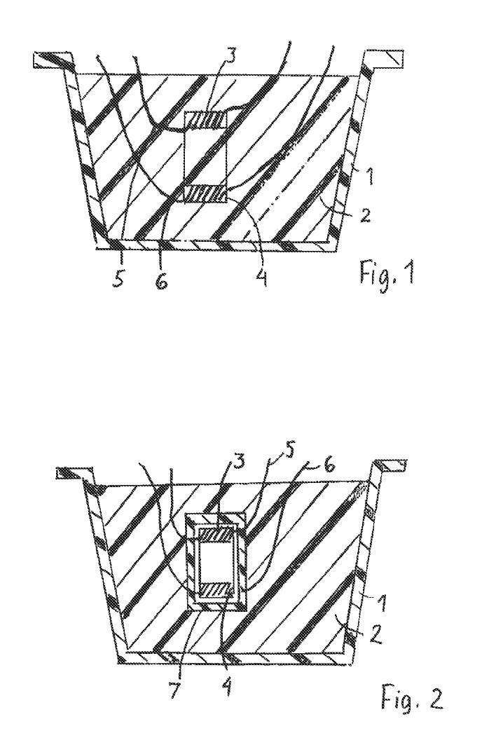

The electric device illustrated in FIG. 1 is a transformer having a first magnetic core 3 and a second magnetic core 4. A primary winding 5 is wound around the first magnetic core 3, and a secondary winding 6 is wound around the second magnetic core 4.

The transformer is encapsulated to provide protection and insulation. The encapsulation consists of an outer part 1 forming a shell and an inner part 2 that is moulded in the shell 1. The shell 1 is made of a thermoplastic material and the inner part 2 is made of a thermosetting material.

The electrical device is an instrument transformer adapted for exterior use. More specifically, the electrical device is a current transformer. Instrument transformers are used in measurement and protective applications, together with equipment, such as meters and relays. An instrument transformer “steps down” the current or voltage of a system to a standardized value that can be handled by associated equipment. For example, a current instrument transformer may step down current in a range of 10 to 2,500 amps to a current in a range of 1 to 5 amps, while a voltage instrument transformer may step down voltage in a range of 12,000 to 40,000 volts to a voltage in a range of 100 to 120 volts.

Each core 3, 4 has an enlarged central opening and is composed of a ferromagnetic material, such as iron or steel. The core 3, 4 may have a rectangular shape or a torroidal or annular shape. The core may be comprised of a strip of steel, such as grain-oriented silicon steel, which is wound on a mandrel into a coil. Alternately, the core may be formed from a stack or stacks of rectangular plates. The low voltage winding comprises a length of wire, such as copper wire, wrapped around the core to form a plurality of turns that are disposed around the circumference of the core. End portions of the low voltage winding are secured to low voltage transformer leads or form the low voltage transformer leads, which are connected to a terminal board mounted to the exterior of the shell. The high voltage winding is connected to high voltage transformer leads (not shown). The high voltage winding may be rectangular, torroidal or annular in shape and is interlinked with the core/coil assembly. The high voltage winding is composed of a conductive metal, such as copper.

The example depicted in FIG. 2 is similar to that from FIG. 1 except from that the magnetic cores 3, 4 and the windings 5, 6 are arranged in an inner box 7. The inner box is made of a thermoplastic material, which can be the same as that of the shell 1 or of another kind.

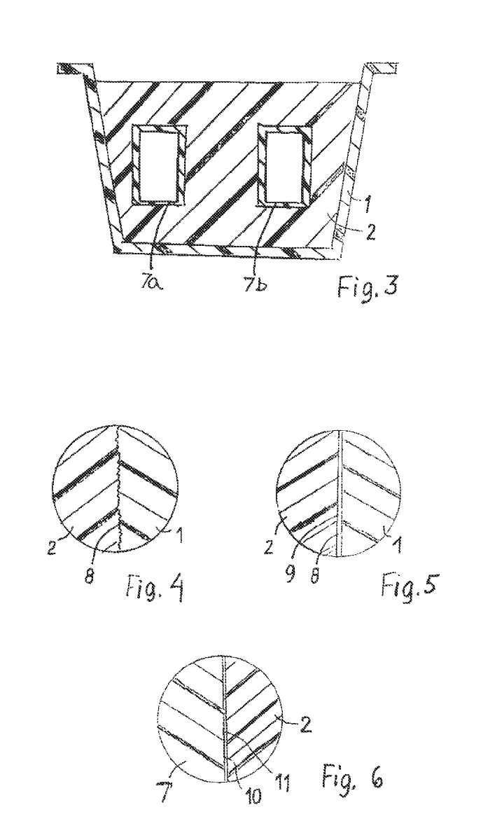

The example of FIG. 3 differs from that in FIG. 3 in that there are two boxes 7a, 7b embedded in the inner part 2. Each of the boxes contains transformer components (not shown).

For the manufacturing of the transformer, the components thereof are placed in the outer shell 1, either directly as in FIG. 1 or within one or more boxes 7, 7a, 7b as in FIG. 2 or 3, respectively. Thereafter the thermosetting resin composition 2 forming the inner part is moulded around the electric components/the boxes, using the shell 1 as the mould form.

The resin composition of the inner part 2 may be a flexible epoxy composition, a flexible aromatic polyurethane composition, butyl rubber, or a thermoplastic rubber.

A suitable flexible epoxy composition that may be used for the inner part 2 may be formed from an epoxy resin, one or more flexibilizers and one or more curing agents or cross-linking agent.

The epoxy resin comprises a polynuclear dihydroxy phenol (a bisphenol) and a halohydrin. Bisphenols which may be used include bisphenol A, bisphenol F, bisphenol S and 4,4′-dihydroxybisphenol. Bisphenol A has been found to be particularly suitable. The halohydrins include epichlorohydrin, dichlorohydrin and 1,2-dichloro 3-hydroxypropane. Epichlorohydrin has been found to be particularly suitable. Typically, excess molar equivalents of the epichlorohydrin are reacted with the bisphenol-A so that up to two moles of epichlorohydrin react with one mole of bisphenol-A.

The flexibilizer may react with the epoxy resin to become part of the cross-linked structure. Such a reactive flexibilizer may be a diglycidyl ether of a polyalkylene oxide or glycol, which may be formed from the reaction product of epichlorohydrin and a polyalkylene glycol, such as the ethylene and propylene oxide adducts of C2 to C4 polyois. Commercially-available reactive flexibilizers which may be used include D. E. R. 732, which is sold by the Dow Chemical Company of Midland, Mich. and which is a reaction product of epichlorohydrin and polypropylene glycol.

The curing agent may be an aliphatic polyamine or adduct thereof, an aromatic polyamine, an acid anhydride, a polyamide, a phenolic resin, or a catalytic type of curing agent. Suitable aliphatic polyamines include diethylene triamine (DETA), triethylene tetramine (TETA) and tetraethylene pentamine (TEPA). Suitable aromatic polyamines include metaphenylene diamine, diamino diphenyl sulfone and diethyltoluene diamine. Suitable acid anhydrides include dodecenyl succinic anhydride, hexahydrophthalic anhydride, methyl hexahydrophthalic anhydride, trimellttic anhydride, phthalic anhydride, tetrahydrophthalic anhydride, methyl tetrahydrophthallic anhydride and nadic methyl anhydride.

A suitable flexible aromatic polyurethane composition that may be used for the resin composition of the inner part 2 is formed from a polyol, a polyisocyanate, a chain extender and optionally a catalyst. The polyol is a low molecular weight (400-10,000) hydroxyl-containing molecule with two or more hydroxyl groups per chain. The polyol may be a polyester polyol, a polycaprolactone polyol or a polyether polyol. Examples of polyester polyois include poly(ethylene adipate) and poly(1,4-butylene adipate). Examples of polyether polyois include polypropylene ether polyois and polytetramethylene ether glycols (PTMEG). The polyisocyanate may be the 2,4 or 2,6 isomer of toluene diisocyanate (TDI), 4,4′-methylene diphenyldiisocyanate (MDI), 1,5-naphthalene diisocyanate (NDI), tolidine diisocyanate (TODI), or p-phenyl diisocyanate (PPDI), or combinations thereof. The chain extender may be an amine and/or a short chain polyol. The amine may be methylene bis(2-chloroaniline) (MCBA) or a mono-tertiary-alkyltoiuenediamine, such as mono-tertiary-butyltoluenediamine. Suitable short chain polyois include ethylene glycol, propylene glycol, butane diol and glycerol. The catalyst may be used to speed up the reaction of the polyol, the polyisocyanate and the chain extender. The catalyst may be an organic metal compound or a tertiary amine, such as triethylamine.

The flexible aromatic polyurethane composition may comprise a polyurethane system designated NB2858-91, which is produced by the Loctite Corporation. NB2858-91 is a 100% solids, two-part polyurethane system. When cured, NB2858-91 has (at 23° C.), a cured density of 1.62 g/cm³ (gm/cc), an initial Shore D hardness of 70-75 and after 10 seconds, a Shore D hardness of 55-60, an elongation of 90%, a thermal conductivity (cal·cm)/(s·cm²·° C.) of 18.1 [or 75.7 W/(cm·° C.)] and a dielectric strength (at 20 mil thickness, volts/mil) of 200 [or 47.24×10⁶ V/m at 0.508 mm thickness].

A suitable thermoplastic rubber that may be used for the resin composition of the inner part 2 may be an ethylene-propylene copolymer elastomer or terpolymer elastomer that is blended with polyethylene or polypropylene. Another suitable thermoplastic rubber may be a block copolymer having blocks of polystyrene and blocks of polybutadiene or polyisoprene.

In the example of FIG. 4 the inner surface 8 of the outer shell 1 has a rough surface structure. In the example of FIG. 5 the inner surface 8 of the outer shell 1 is coated with a layer 9 that has good adherence to the inner part.

In the example of FIG. 6, the outer surface 10 of the at least one inner box 7 has a thin semiconducting layer 11, that can be a paint or a tape.

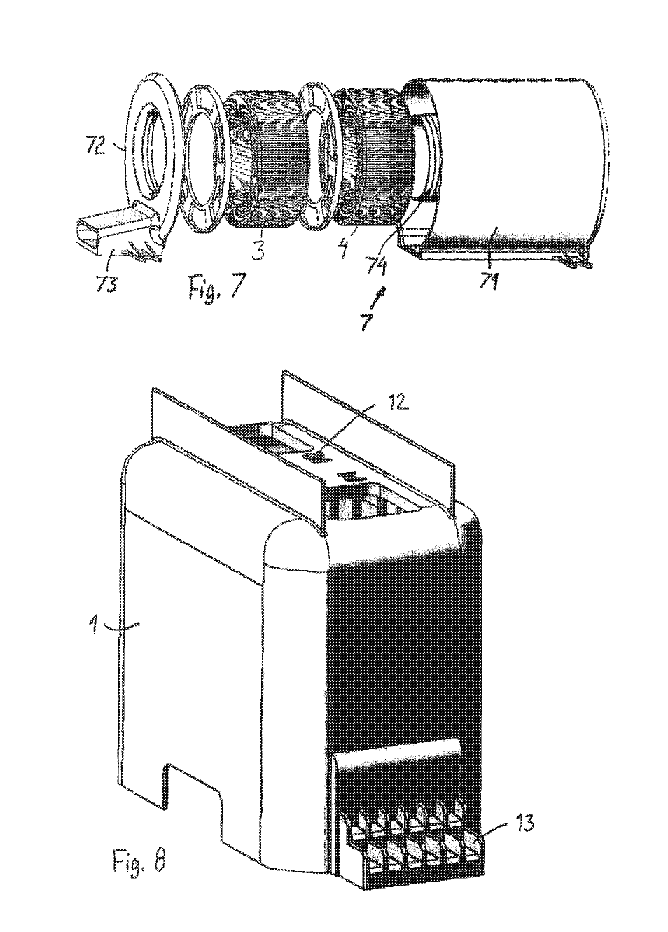

FIGS. 1 to 3 are schematic figures in order to more clearly explain the principle of the invention. FIGS. 7 and 8 illustrates examples of how parts of the invented electric device can be designed. FIG. 7 illustrates the box 7, containing the electric components. The box has a substantially cylindrical casing 71 and a cover 72 with a portion 73, through which the electrical connections extend. Inside the casing 71 and being integral therewith is a cylindrical holder 74 on which the magnetic cores 3, 4 of the transformer are mounted.

FIG. 8 illustrates the shell 1, having terminal board 13 for the secondary winding and terminal board 12 for the primary winding.

1. An electric device including components which comprise a plurality of windings and magnetic cores, the device further including an encapsulating plastic encasement, which encasement includes an inner part and an outer part, the inner part being an inner insulating resin composition of thermosetting material encapsulating components of the electric device, and the outer part being a shell which at least partly encloses the resin composition in contact therewith, the shell being made of a thermoplastic material, characterized in that the plurality of windings and magnetic cores of the components of the electric device are located in at least one inner box encapsulated by the inner insulating resin composition.

2. The electric device according to claim 1, characterized in that the electric device is a sensor or a transformer.

3. The electric device according to claim 2, characterized in that the electric device is a transformer for a voltage higher than 1 kV.

4. The electric device according to claim 1, characterized in that at least one of the inner box(es) is made of a thermoplastic material.

5. The electric device according to claim 1, characterized in that the internal surface of the shell has a rough or coated surface.

6. The electric device according to claim 1, characterized in that the external surface of the at least one inner box has an outer layer of semi conductive paint or tape.

7. The electric device according to claim 1, characterized in that the material of the shell is selected from the group of materials consisting of PBT, PET, PA, PPSU, PSU, PES and PPS.

8. The electric device according to claim 1, characterized in that the inner part has a tensile elongation at break of greater than 5%.

9. The electric device according to claim 1, characterized in that the material of the inner part has a thickness that is greater than the thickness of the shell.

10. The electric device according to claim 1, characterized in that the at least one inner box is at least partially filled with a filler comprising an insulating resin composition.

11. A method for manufacturing an electric device, which device includes components comprising a plurality of windings and magnetic cores, and including the steps of providing a shell, inserting at least some of the components into the shell and moulding an insulating resin composition of thermosetting material into the shell such that the resin composition encapsulates said components, the shell provided being of a thermoplastic material that is used as the mould form when moulding the insulating resin composition of thermosetting material, characterized in that the plurality of windings and magnetic cores of the components of the electric device are placed in at least one box before inserting them into the shell, and in that the at least one inner box is encapsulated by the inner insulating resin composition.

12. The method according to claim 11, characterized in that before moulding the insulating resin composition, the internal surface of the shell is treated by roughening or coating the surface.

13. The method according to claim 11, characterized in that an outer layer of semi conductive paint or tape is applied to the external surface of the at least one inner box.

14. The method according to claim 11, characterized in that the electric device includes an encapsulating plastic encasement, which encasement includes an inner part and an outer part, the inner part being an inner insulating resin composition of thermosetting material encapsulating components of the electric device, and the outer part being a shell which at least partly encloses the resin composition in contact therewith.

15. The method according to claim 11, characterized in that the at least one inner box is at least partially filled with a filler comprising an insulating resin composition.
